(19) United States
(12) Patent Application Publication
(10) Pub. No.: US 2008/0072400 A1
(43) Pub. Date: Mar. 27, 2008

(54) Handle For Cosmetic Products Applicator

(75) Inventor: Fabrice Dieudonat, Fosses (FR)

Correspondence Address: BANNER & WITCOFF, LTD., TEN SOUTH WACKER DRIVE, SUITE 3000, CHICAGO, IL, 60606, US

(73) Assignee: ALCAN PACKAGING BEAUTY SERVICES, GENNEVILLIERS (FR)

(21) Appl. No.: 11/534,071

(22) Filed: Sep. 21, 2006

(51) Int. Cl. B25G 3/32

(52) U.S. Cl. 16/422

(57) ABSTRACT

A handle for a cosmetic product applicator can include a body fitted with an attachment end piece. The body can be generally flattened in shape and delimited by two parallel surfaces corresponding to the gripping faces, and a rounded edge. Each gripping face may be formed by a concave surface on the side of the median plane located between the two parallel surfaces, the two concave surfaces may be substantially symmetric and each shaped to form an area acting as a finger support. The handle may be detachable from the applicator at the attachment end piece and easily used with a complete series of specific applicators.

### FIELD OF THE INVENTION

The field of the invention relates to a handle for a cosmetic product applicator. More specifically, this handle is particularly suitable to be fitted with applicator end pieces such as for the treatment of eyelashes. The applicators may possibly comprise, for example, bristles or foam.

### BACKGROUND OF THE INVENTION

Handles provided with applicators are very often cylindrical in shape and users are required to hold them like a pencil. Therefore there is no preferred gripping area, and the result is a lack of comfort and precision when applying the product.

### BRIEF SUMMARY OF THE INVENTION

Embodiments of the invention provide a handle for a cosmetic product applicator with a compact structure, the shape of which imposes correct gripping by the user and facilitates the application precision of the cosmetic product. To achieve this, the handle according to an embodiment of the invention includes a body, fitted with an applicator attachment end piece, wherein the body is generally flattened in shape and is delimited by two parallel surfaces corresponding to the gripping faces and a rounded edge. Each gripping face may be formed by a concave surface on the side of the median plane located between the two parallel surfaces, the two concave surfaces being substantially symmetric and each shaped to form an area acting as a finger support.

Therefore, the user may grip the handle between two fingers, for example between the thumb and the index finger. The two fingers may thus be positioned in the bottoms of two concave surfaces, one facing the other, giving a grip of the applicator such that it can comfortably be used with high precision.

Advantageously, in certain aspects, the two concave surfaces can be in communication with and define a hole in the area acting as a support for the two fingers.

Furthermore, in an aspect of the invention, each concave surface is inclined uniformly from the edge to the finger support area. This inclination of the two concave surfaces enables the gripping fingers to be stabilized, so that the fingers come into contact through the hole formed in the body, making it easier to hold the handle and improving conditions for use of the applicator.

According to one embodiment of this handle, the body has a generally semi-circular shaped part as seen from above, the finger support area being located in the center of this part, joined by an elongated part at the end of which the applicator attachment end piece is located.

In order to improve the comfort of this applicator during use, the body of the handle may be made from a semi-flexible synthetic material, or from a hard synthetic material on which, for example, a flexible coating is placed by insert molding.

### BRIEF DESCRIPTION OF THE FIGURES

Aspects of the invention are disclosed in the appended figures showing embodiments of the handle, as non-limiting examples:

FIG. 1 shows a perspective view of a handle.

FIG. 2 shows an elevation view of a handle with an applicator for which the handle is partially cut.

FIG. 3 shows a view of the handle of FIG. 2 along line I-III.

FIG. 4 shows a view of the handle of FIG. 2 along line IV-IV.

### DETAILED DESCRIPTION OF EMBODIMENTS OF THE INVENTION

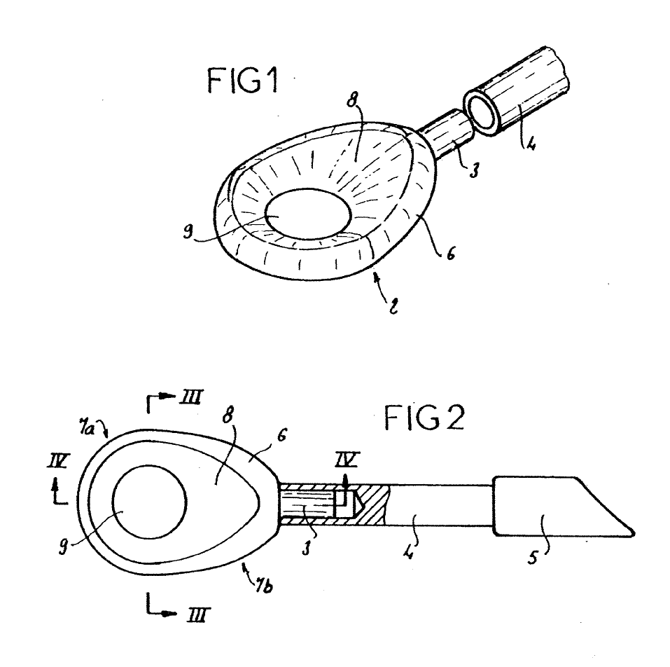

Referring to FIGS. 1 and 2, the handle for a cosmetic product applicator according to an aspect of the invention includes a body 2 with an attachment end piece 3 for the wand 4 of an applicator 5. In the embodiments shown in FIGS. 1 and 2, the wand 4 of the applicator is tubular and engages on the attachment end piece 3 of the body 2 of the handle. This attachment may be permanent or it may be removable.

In other embodiments an end piece 3 replaces the wand 4 of the applicator and directly receives the part 5, forming an applicator.

In the embodiment shown in FIG. 2, the body has, in a top view, a part 7a with a generally semi-circular shape joined by an elongated profiled part 7b that may be provided with the applicator attachment end piece 3 at its end.

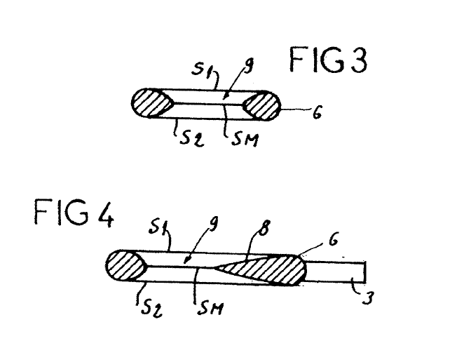

Referring to FIGS. 3 and 4, the body 2 of the handle is generally flat in shape, being delimited by two parallel surfaces S1 and S2 and by a rounded peripheral edge 6.

As shown in FIGS. 1 through 4, embodiments of the applicator include two opposite gripping faces, each composed of a surface 8 inclined from an external plane, S1, S2, respectively, to a median plane SM located at mid-distance between planes S1 and S2, respectively. Each gripping face 8 is inclined from the edge 6 towards the center of the semi-circular part 7a, in which the two surfaces 8 located on each side of the central surface SM may be in communication and define a hole 9. The various figures show that the surfaces 8 can be continuously inclined, which may make them particularly ergonomic.

In practice, and in the embodiments shown in the drawings, each applicator may be fitted removably on the handle. Therefore the operator can choose the applicator to be adapted onto the handle as a function of the area to be made up, and personal taste. Once the applicator is fixed on the handle, the operator may grip the handle, for example between the thumb and index finger, these two fingers bearing on the two opposite concave surfaces 8 and the ends of the two fingers touching each other through the hole 9, if a hole 9 is present in the particular embodiment. Since the handle is made from a semi-flexible material, or is coated with a semi-flexible material, the grip of the handle is secure and comfortable, and the user can use the applicator with a suitable degree of precision.

As can be seen from the above, embodiments of the invention provide an improvement to existing art by providing an ergonomic handle with a simple structure, giving a comfortable grip and precise gestures.

It is obvious that the invention is not limited to the embodiment of this applicator described above, and it further includes all variants. Thus for example, the two concave surfaces 8 may not communicate, or the shape of the body could be different, for example it could be a completely circular shape, without going outside the framework of the invention.

The invention also provides a means for applying cosmetic products like that shown for example in FIG. 2, including a handle 2 fixed to an applicator 4, 5.

In other aspects, a cosmetic product application assembly includes a handle 2 and a plurality of typically distinct applicators 4, 5, such that a single handle can easily be used with a complete series of specific applicators.

What is claimed is:

1. A handle for a cosmetic product applicator comprising:
a body including an end piece for attachment of an applicator, the body having a generally planar shape delimited by two parallel surfaces with a rounded edge extending therebetween;
the two parallel surfaces comprising two opposing gripping faces, the two opposing gripping faces being symmetric and each including a concave surface; and
each of the concave surfaces providing a finger support area.

2. The handle according to claim 1, wherein the two concave surfaces include an opening in the finger support areas, the opening extending between the two concave surfaces such that the two concave surfaces are in communication with each other.

3. The handle according to claim 1, wherein eachthe two concave surfaces each are inclined uniformly from the rounded edge to the finger support areas.

4. The handle according to claim 1, wherein the body has a generally semi-circular portion including the finger support areas and an elongated portion including the end piece for attachment of the applicator.

5. The handle according to claim 1, wherein the body comprises a semi-flexible synthetic material.

6. The handle according to claim I, wherein the body comprises a hard synthetic material with a flexible coating deposited by insert molding.

7. A means for applying cosmetic products including a handle fixed to an applicator,
wherein the handle comprises a body including an end piece for attachment of an applicator, the body having a generally planar shape delimited by two parallel surfaces with a rounded edge extending therebetween, and wherein the two parallel surfaces comprise two opposing gripping faces, the two opposing gripping faces being symmetric and each including a concave surface; and
wherein each of the concave surfaces provides a finger support area.

8. A cosmetic product application assembly including a handle and a plurality of generally distinct applicators,
wherein the handle comprises a body including an end piece for attachment of an applicator, the body having a generally planar shape delimited by two parallel surfaces with a rounded edge extending therebetween, and wherein the two parallel surfaces comprise two opposing gripping faces, the two opposing gripping faces being symmetric and each including a concave surface; and
wherein each of the concave surfaces provides a finger support area.

9. The handle according to claim 1 wherein the body has a circular shaped part as seen from above with the finger support areas located in the center of the circular part.

10. The handle according to claim 1 wherein the attachment end piece engages a tubular application wand.

11. The handle according to claim 1 wherein the attachment end piece engages an applicator.

12. The handle according to claim 1 wherein the attachment end piece removably engages an applicator.

13. The handle according to claim 1 wherein the handle is coated with a semi-flexible material.

14. A handle for a cosmetic product applicator comprising:
a body of generally planar shape, the body comprising:
a first concave surface providing a first gripping surface;
a second concave surface providing a second gripping surface, the second concave surface substantially parallel to the first concave surface, the first concave surface and the second concave surface each being outwardly opposed to provide two opposing finger support areas; and
an opening extending through the body between the first concave surface and the second concave surface.

15. The handle according to claim 14 further comprising a rounded edge extending between the first gripping surface and the second gripping surface.

16. The handle according to claim 15, wherein the first concave surface and the second concave surface are inclined uniformly from the rounded edge to the finger support areas.

17. The handle according to claim 16 wherein the body has a generally semi-circular portion including the finger support areas and an elongated portion including an end piece for attachment of the applicator.

18. The handle according to claim 16 wherein the attachment end piece removably engages an applicator.

19. The handle according to claim 14, wherein the body comprises a semi-flexible synthetic material.

20. The handle according to claim 14, wherein the body comprises a hard synthetic material with a flexible coating.
